(19) United States
(12) Patent Application Publication
(10) Pub. No.: US 2025/0254172 A1
(43) Pub. Date: Aug. 7, 2025

(54) ACCOUNT PERMISSIONS MANAGEMENT TAB

(71) Applicant: The Toronto-Dominion Bank, Toronto (CA)

(72) Inventors: Simona HEATH, Toronto (CA); Shishir Dattatraya BHAT, Toronto (CA); Patti TUFF, Ottawa (CA); Edward SPENCER, Richmond Hill (CA); Abhimanyu MUNJAL, Mississauga (CA)

(73) Assignee: The Toronto-Dominion Bank, Toronto (CA)

(21) Appl. No.: 18/435,036

(22) Filed: Feb. 7, 2024

(51) Int. Cl. H04L 9/40; G06F 3/04817; G06F 3/0482

(52) U.S. Cl. CPC H04L 63/102; G06F 3/0482; G06F 3/04817

(57) ABSTRACT

The present disclosure relates to system and methods for managing permission sharing. There is provided a computer system configured to provide, in an account view of an account, a selectable option to manage sharing permissions for third-party systems defined for the account. The computer system is configured to receive an indication via the selectable option to manage the sharing permissions of the third-party systems, and in response to receiving the indication, display a listing including only the third-party systems for which the sharing permissions for the account have been previously configured, the listing having one or more interface elements for receiving a listing instruction in association with the listing. The computer system is further configured to receive the listing instruction via the one or more interface elements, and in response to receiving the listing instruction, provide a management interface related to the listing.

### TECHNICAL FIELD

The present application relates to open banking and, more particularly, to systems and methods for managing account permissions with a management tab.

### BACKGROUND

Open banking allows a user to permit their financial institution to share some of their financial data with third-party applications or other financial institutions. This allows the third-party applications or other financial institutions to provide more personalized financial products or suggestions to the user. Examples include personal financial management (PFM) systems to help a customers manage money, fast credit applications, direct debit travel cards, paid subscription management etc. However, as a user grants permissions to a greater number of third-party systems or other financial institutions, it becomes difficult for the user to keep track of, and to manage, which third-parties were granted permissions, and which specific permissions were granted to which third-parties.

### BRIEF DESCRIPTION OF THE DRAWINGS

Embodiments are described in detail below, with reference to the following drawings:

FIG. 1 is a schematic operations diagram illustrating an operating environment of a system according to an example embodiment of the present disclosure;

FIG. 2 is a simplified schematic diagram showing components of a client device of FIG. 1;

FIG. 3 is a simplified schematic diagram showing components of a computer system and a database of FIG. 1;

FIG. 4 is a high-level schematic diagram of an example computer device;

FIG. 5 shows a simplified organization of software components stored in a memory of the example computer device of FIG. 4; and

FIGS. 6 and 7 are flowcharts showing operations performed by a computer system for managing sharing permissions according to example embodiments of the present disclosure; and

FIGS. 8 to 10 are example user interfaces that may be displayed during operation of the methods of FIGS. 6 and 7.

Like reference numerals are used in the drawings to denote like elements and features.

### SUMMARY

In one aspect of the present disclosure, there is provided a computer system comprising: a processor; a communications module coupled to the processor; and a memory coupled to the processor, the memory storing instructions that, when executed, configure the processor to: provide, in an account view of an account, a selectable option to manage sharing permissions for third-party systems defined for the account; receive an indication via the selectable option to manage the sharing permissions of the third-party systems; in response to receiving the indication, display a listing including only the third-party systems for which the sharing permissions for the account have been previously configured, the listing having one or more interface elements for receiving a listing instruction in association with the listing; receive the listing instruction via the one or more interface elements; and in response to receiving the listing instruction, provide a management interface related to the listing.

In some implementations, the instructions further configure the processor to display a selectable icon for each of the third-party systems in the listing for which sharing permissions has been previously configured, the one or more interface elements comprising the selectable icons.

In some implementations, in response to receiving the listing instruction via one of the selectable icons, the instructions further configure the processor to provide the management interface with options for managing the sharing permissions for the third-party system associated with the one of the selectable icons.

In some implementations, the listing is ordered based on one or more of: a time at which the sharing permission of each third-party system was defined; a risk score defined for each third-party system; and an amount of data being shared according to the sharing permission of each third-party system.

In some implementations, the instructions further configure the processor to display the listing with all the third-party systems for which sharing permissions for the account have been previously configured.

In some implementations, the instructions further configure the processor to display the listing with a subset of the third-party systems for which sharing permissions for the account have been previously configured.

In some implementations, the one or more interface elements further comprises a selectable expansion option, and in response to receiving the listing instruction via the selectable expansion option, the instructions further configure the processor to provide the management interface with all of the third-party systems for which sharing permissions for the account have been previously configured.

In some implementations, the instructions further configure the processor to query a database to retrieve the sharing permissions for the third-party systems defined for the account.

In some implementations, the instructions further configure the processor to receive a given sharing permission of a given third-party system defined for the account, and save the given sharing permission of the given third-party system to the database in association with the account.

In another aspect of the present disclosure, there is provided a computer-implemented method comprising: providing, in an account view of an account, a selectable option to manage third-party system sharing permissions defined for the account; receiving an indication via the selectable option to manage the third-party system sharing permissions; in response to receiving the indication, displaying a listing including only third-party systems for which sharing permissions for the account have been previously configured, the listing having one or more interface elements for receiving a listing instruction in association with the listing; receiving the listing instruction via the one or more interface elements; and in response to receiving the listing instruction, providing a management interface related to the listing.

In some implementations, displaying the listing comprises displaying a selectable icon for each of the third-party systems in the listing for which sharing permissions has been previously configured, the one or more interface elements comprising the selectable icons.

In some implementations, in response to receiving the listing instruction via one of the selectable icons, the method further comprises providing the management interface with options for managing the sharing permissions for the third-party system associated with the one of the selectable icons.

In some implementations, the method further comprises ordering the listing based on one or more of: a time at which the sharing permission of each third-party system was defined; a risk score defined for each third-party system; and an amount of data being shared according to the sharing permission of each third-party system.

In some implementations, displaying the listing comprises displaying all of the third-party systems for which sharing permissions for the account have been previously configured.

In some implementations, displaying the listing comprises displaying a subset of the third-party systems for which sharing permissions for the account have been previously configured.

In some implementations, the one or more interface elements further comprises a selectable expansion option, in response to receiving the listing instruction via the selectable expansion option, the method further comprising providing the management interface with all of the third-party systems for which sharing permissions for the account have been previously configured.

In some implementations, the method further comprises retrieving the third-party system sharing permissions defined for the account from a database.

In some implementations, the method further comprises receiving a given sharing permission of a given third-party system for the account, and saving the given sharing permission of the given third-party system to the database in association with the account.

In another aspect of the present disclosure, there is provided a non-transitory computer readable medium having stored thereon processor-executable instructions which, when executed by at least one processor, configure the at least one processor to: provide, in an account view of an account, a selectable option to manage third-party system sharing permissions defined for the account; receive an indication via the selectable option to manage the third-party system sharing permissions; in response to receiving the indication, display a listing including only third-party systems for which sharing permissions for the account have been previously configured, the listing having one or more interface elements for receiving a listing instruction in association with the listing; receiving the listing instruction via the one or more interface elements; and in response to receiving the listing instruction, providing a management interface related to the listing.

In the present application, the term “and/or” is intended to cover all possible combinations and sub-combinations of the listed elements, including any one of the listed elements alone, any sub-combination, or all of the elements, and without necessarily excluding additional elements.

Other aspects and features of the present application will be understood by those of ordinary skill in the art from a review of the following description of examples in conjunction with the accompanying figures.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

### DETAILED DESCRIPTION OF VARIOUS EMBODIMENTS

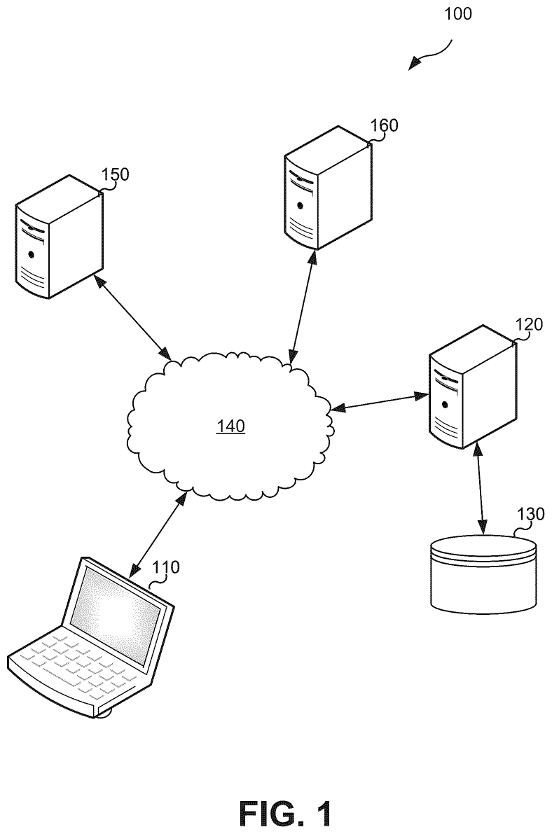

FIG. 1 is a schematic operation diagram illustrating an operating environment of an example embodiment. As shown, the system 100 includes a client device 110 and a computer system 120 with a database 130, coupled to one another through a network 140, which may include a public network such as the Internet and/or a private network. The client device 110 and the computer system 120 may be in geographically disparate locations. In other words, the client device 110 and the computer system 120 may be located remote from one another. The system 100 may further include data provider computer systems, such as a real-time data provider computer system 150 and an open banking computer system 160. These may also be coupled to the client device 110 and the computer system 120 through the network 140.

The client device 110 may be a laptop computer as shown in FIG. 1. However, the client device 110 may be a computing device of another type such as for example a smartphone, a personal computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments. The client device 110 may be associated with an entity, such as a user or client,

The computer system 120 may be, for example, a mainframe computer, a minicomputer, or the like. In some embodiments thereof, a computer system may be formed of or may include one or more computing devices. The computer system 120 may include and/or may communicate with multiple computing devices such as, for example, database servers (including a database 130), computer servers, and the like. Multiple computing devices such as these may be in communication using a computer network and may communicate to act in cooperation as a computer server system. For example, the computing devices may communicate using a local-area network (LAN). In some embodiments, the computer system 120 may include multiple computing devices organized in a tiered arrangement. For example, the computer system 120 may include middle tier and back-end computing devices. In some embodiments, the computer system 120 may be a cluster formed of a plurality of interoperating computing devices.

The computer system 120 may be associated with or used by one of various institutions. In some embodiments, the computer system 120 may be associated with a financial institution and, to that end, may maintain records of customer financial accounts and associated financial data in the database 130. The database 130 may be provided internally within the computer system 120 or externally. To that end, the database 130 may be provided remotely from the computer system 120. For example, the database 130 may be stored in one or more data centers, and the data centers may store data with bank-grade security.

The database 130 may include records associated with a plurality of users or entities, including the user associated with the client device 110. The records may be for a plurality of accounts and at least some of the records may define or store resources. The records may also define a quantity of resources. In some embodiments, the user that is associated with the client device 110 may be associated with an account having one or more records in the database 130. The records may reflect a quantity of stored resources that are associated with the user. Such resources may include owned resources and, in at least some embodiments, borrowed resources. The resources that are associated with a user may be grouped into various buckets. Some such buckets may, for example, represent individual bank accounts. For example, a user may be associated with one or more bank accounts. At least some of the resources may be borrowed resources. The borrowed resources may, for example, represent an amount of credit that is available to the user. The user that is associated with the client device 110 and the account may be a customer of the financial institution which operates or manages the computer system 120.

The network 140 is a computer network. In some embodiments, the network 140 may be an internetwork such as may be formed of one or more interconnected computer networks. For example, the network 140 may be or may include an Ethernet network, an asynchronous transfer mode (ATM) network, a wireless network, a telecommunications network, or the like.

The system 100 may further include one or more third-party systems or data provider computer systems who offer financial products and/or services to the user associated with the client device 110 traditionally not offered by the financial institution. The data provider computer systems may be in communication with the client device 110 and the computer system 120 through the network 140. The data provider computer systems may include one or more real-time data provider computer systems 150 and/or one or more open banking computer systems 160. While the example shown in FIG. 1 shows the system 100 having one real-time data provider computer system 150 and one open banking computer system 160, it will be appreciated that the system 100 may include more than one real-time data provider computer system 150 and more than one open banking computer system 160.

The real-time data provider computer system 150 may be associated with a third party configured to receive financial data from the computer system 120 and provide real-time data to the computer system 120. For example, the real-time data provider computer system 150 may be associated with a credit bureau or credit score manager and, as such, may communicate real-time data associated with a customer. For example, real-time data associated with the customer may include a real-time credit score of the customer. As another example, the real-time data provider computer system 150 may be associated with a fraud alert system and, as such, may communicate real-time data associated with a customer. Such real-time data associated with the customer may include fraud alerts and/or indications that a fraud alert has been issued for one or more banking products associated with the customer. It will be appreciated that in embodiments where the system includes a plurality of real-time data provider computer systems 150, each real-time data provider computer system 150 may be associated with a different third party and/or may provide different types of real-time data. As will be described, the computer system 120 may request the real-time data in response to receiving an application programming interface request.

The open banking computer system 160 may be associated with a third party configured to receive financial data from the computer system 120 and provide real-time data such as open banking data to the computer system 120. For example, the open banking computer system 160 may be associated with another financial institution or a mobile application such as, for example, a money management application that may be configured to pull real-time data for banking products associated with the customer. The financial data may include, for example, a balance of a bank account, a balance of a mortgage, an indication as to whether the customer has applied for one or more banking products within a particular time period, a summary of deposits made within a bank account, etc.

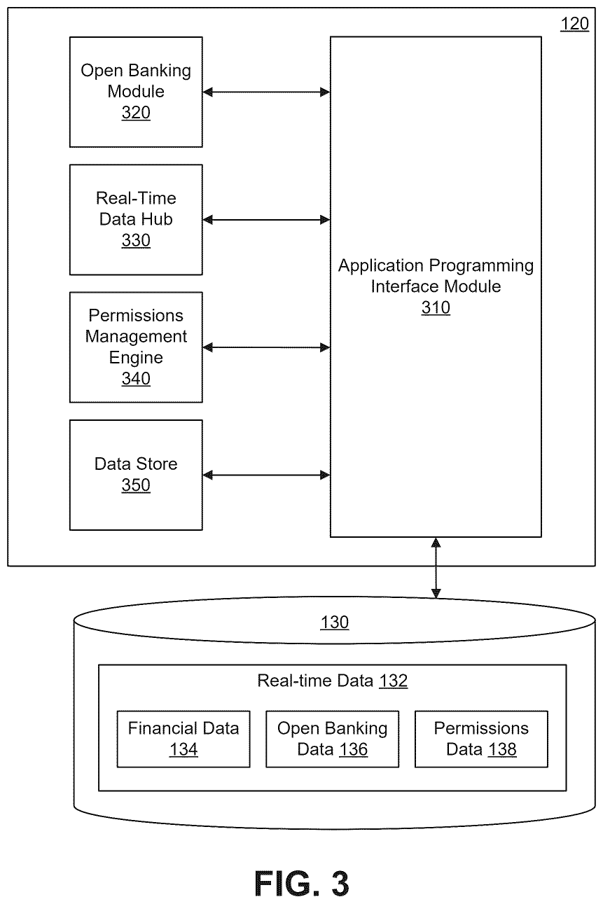

In order for the real-time data provider computer system 150 and the open banking computer system 160 to provide their respective services to the user, they may require access to, or they be provided with, at least some of the financial data of the user that may be stored in the database 130 (and/or a data store 350, discussed in greater detail below with reference to FIG. 3). To that end, the client device 110 may be configured to receive instructions from the user to grant authorization or permission for the computer system 120 to share the user's financial data (stored in the database 130) with the real-time data provider computer system 150 and/or the open banking computer system 160. The financial data of the user may be retrieved from the database 130 by the computer system 120 and sent to the real-time data provider computer system 150 and/or the open banking computer system 160 via the network 140 using a secured application programming interface call or request, for example.

This permission or authorization for the computer system 120 to share the user's financial data with the real-time data provider computer system 150 and/or the open banking computer system 160 may itself be stored in the database 130 as permissions data associated with the user account. The permissions data may form part of the real-time data or open banking data or may be considered a separate set of data. The permissions data may include the identity of the third-party (i.e. the real-time data provider computer system 150 and/or the open banking computer system 160) that has been granted permission by the user to receive financial records associated with the user from the computer system 120, other user and/or background information relating to the third-party, including user reviews, its trustworthiness, or risk score, which financial records and/or how much financial data associated with the user may be shared with that third-party, how often the financial records may be shared with the third-party, when permission renewals are required, when each permission was granted, and any other details of, or conditions under which, the financial records are to be shared with the third-party etc.

FIG. 1 illustrates an example representation of components of the system 100. The system 100 can, however, be implemented differently than the example of FIG. 1. For example, various components that are illustrated as separate systems in FIG. 1 may be implemented on a common system. By way of further example, the functions of a single component may be divided into multiple components. In another embodiment, the system 100 may be a cloud-based system. For example, the computer system 120 may itself be virtual and the various components and modules thereof may be resident on the cloud. The computer system 120 may include one or more virtual machines or virtual processors that may be accessed via the cloud.

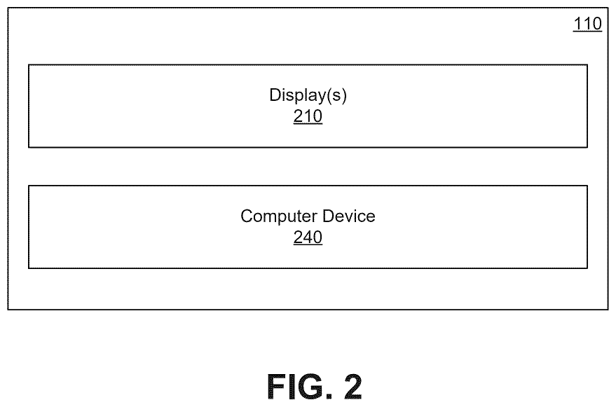

FIG. 2 is a simplified schematic diagram showing components of an exemplary computing device, such as the client device 110. The client device 110 may include modules including, as illustrated, for example, one or more displays 210 and a computer device 240.

The one or more displays 210 are a display module. The one or more displays 210 are used to display screens of a graphical user interface that may be used, for example, to communicate with the computer system 120. The one or more displays 210 may be internal displays of the client device 110 (e.g., disposed within a body of the computing device).

The computer device 240 is in communication with the one or more displays 210. The computer device 240 may be or may include a processor which is coupled to the one or more displays 210.

FIG. 3 is a simplified schematic diagram showing components of the computer system 120 and the database 130. As discussed above, the database 130 may include real-time data 132, which may include financial data 134, open banking data 136, and permissions data 138. While the financial data 134, open banking data 136, and permissions data 138 are illustrated to as separate data categories of the real-time data 132, in some embodiments, they may instead be separate from the real-time data 132, and/or they may overlap with one another. For example, the open banking data 136 may be a subset of the financial data 134, and/or the open banking data 136 may include or be the permissions data 138.

The computer system 120 may include an application programming interface module 310, an open banking module 320, a real-time data hub 330, a permissions management engine 340 and/or a data store 350.

The application programming interface module 310 may act as a software intermediary that allows an application executing on the client device 110 to communicate with an application executing on the computer system 120. The application programming interface module 310 may allow the client device 110 to request data and may enable the computer system 120 to obtain and provide the requested data to the client device 110.

The application programming interface module 310 may be configured to receive application programming interface requests that define parameters. The application programming interface module 310 may perform operations to obtain data to fulfill the application programming interface requests.

In one or more embodiments, the application programming interface module 310 may include a representational state transfer (REST) application programming interface. The REST application programming interface may utilize Hypertext Transfer Protocol (HTTP) methods (e.g. GET, POST) to receive and respond to application programming interface requests. The REST application programming interface may obtain data according to application programming interface requests and may return fixed data sets as a response to the application programming interface requests.

In one or more embodiments, the application programming interface module 310 may include a GraphQL application programming interface. The GraphQL application programming interface may be hierarchical. The GraphQL application programming interface may obtain data according to application programming interface requests without under fetching or over fetching data.

The application programming interface module 310 may include both the REST application programming interface and the GraphQL schemas and may perform operations to select one of the REST and GraphQl application programming interfaces. In one or more embodiments, the computer system 120 may receive an application programming interface request in a format compliant with one of the application programming interface schemas and may translate the request into another format.

The open banking module 320 is in communication with the one or more open banking computer systems 160. The open banking module 320 may communicate with the one or more open banking computer systems 160 directly or through the network 140 to obtain real-time data such as the open banking data 136.

The real-time data hub 330 is in communication with the one or more real-time data provider computer systems 150. The real-time data hub 330 may communicate with the one or more real-time data provider computer systems directly or through the network 140 to obtain the real-time data 132.

Although the real-time data hub 330 and the open banking module 320 are shown as separate modules, it will be appreciated that in one or more embodiments the real-time data hub 330 may include the open banking module 320.

The permissions management engine 340 may be in communication with the open banking module 320, the real-time data hub 330, and/or the database 130, and may be configured to collect, organize, and provide the permissions data from the open banking module 320, the real-time data hub 330, and/or the database 130 to the client device 110 in a manageable format. The permissions management engine 340 may also be configured to analyze the real-time data, including the open banking data and the permissions data, to help organize the permissions data. For example, the permissions management engine 340 may include risk parameters that may be used to analyze the trustworthiness or riskiness of a given real-time data provider computer system 150 or open banking computer system 160. The permissions management engine 340 may also include data parameters that may be used to analyze the volume or amount of data provided to the real-time data provider computer system 150 or the open banking computer system 160. The analyzed data and determinations may be stored in the database 130 and/or the data store 350 as further permissions data. The permissions management engine 340 is also configured to perform a number of operations, as will be further described below with regards to methods 600 and 700.

The data store 350 may include various data records, and may be used instead of, or together with, the database 130. At least some of the data records may store data such as for example non-real-time data. The non-real-time data may include data associated with one or more customers or users of the financial institution. The data may be, for example, borrowing data that may be used to make a real-time borrowing decision. Other examples of non-real-time data for a given user may include a name, an address, an email address, a data of birth, a social security number, etc. At least some of the non-real-time data may include data required to comply with Know-Your-Customer (KYC) compliance requirements. The non-real-time data may additionally include historical data or data previously obtained for the customer from one or more data providers. In one or more embodiments, the non-real-time data may be obtained from the open banking module 320 and/or the real-time data hub 330 and may be stored in the data store 350. For example, the non-real-time data may include historical data relating to a customer's credit score and this may be obtained, for example, every six (6) months from a data provider such as the real-time data provider computer system 150. In one or more embodiments, at least some of the non-real-time data may be used by the computer system 120 to obtain real-time data, open banking data, and/or permissions data from one or more data providers.

The computer system 120 may precondition the various data prior to be stored in the database 130 and/or the data store 350 such that it may be readily available for use by the computer system 120. For example, the computer system 120 may periodically obtain real-time data (including permissions data) from the real-time data provider computer system 150 and/or the open banking computer system 160 by way of the real-time data hub 330 and/or the open banking module 320, respectively. The data may be passed through a batch processing module configured to automatically batch the data. The data that is batch processed may then be passed through a data ingestion module and an extract, transform and load (ETL) module where it is then stored in the data store. In this manner, the data stored in the data store may be readily available for use in generating an application programming interface response.

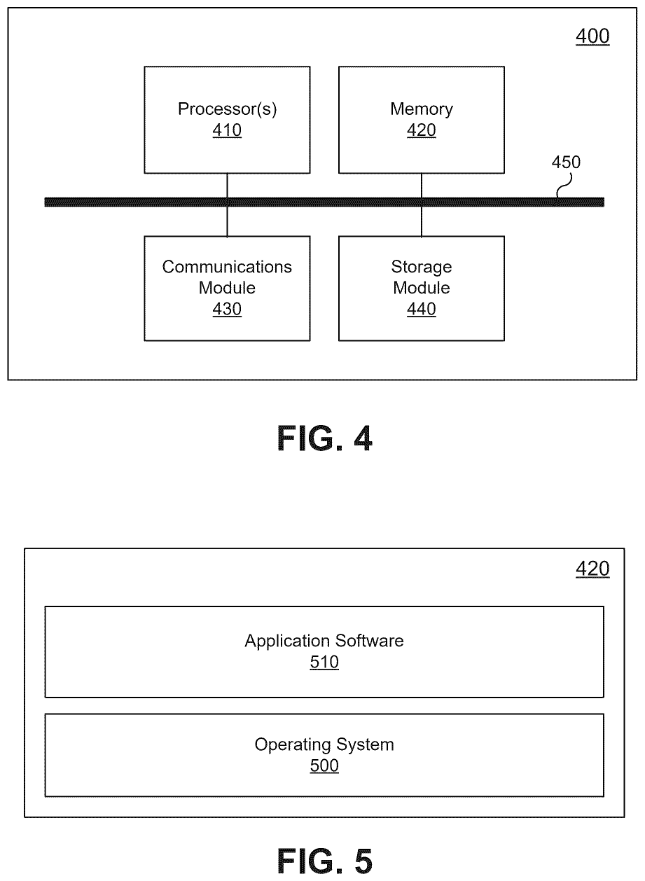

Referring now to FIG. 4, a high-level operation diagram of an example computing device 400 is shown. In some embodiments, the example computing device 400 may be exemplary of the computing device 240 (shown in FIG. 2), the computer system 120, the real-time data provider computer system 150 and/or the open banking computer system 160 (shown in FIG. 1).

The example computing device 400 includes a variety of modules. For example, as illustrated, the example computing device 400 may include at least one processor 410, a memory 420, a communications module 430, and/or a storage module 440. As illustrated, the foregoing example modules of the example computing device 400 are in communication over a bus 450.

The at least one processor 410 is a hardware processor. The at least one processor 410 may, for example, be one or more ARM, Intel x86, PowerPC processors or the like.

The memory 420 allows data to be stored and retrieved. The memory 420 may include, for example, random access memory, read-only memory, and persistent storage. Persistent storage may be, for example, flash memory, a solid-state drive, or the like. Read-only memory and persistent storage are non-transitory computer-readable storage mediums. A computer-readable medium may be organized using a file system such as may be administered by an operating system governing overall operation of the example computing device 400.

The communications module 430 allows the example computing device 400 to communicate with other computer or computing devices and/or various communications networks. For example, the communications module 430 may allow the example computing device 400 to send or receive communications signals. Communications signals may be sent or received according to one or more protocols or according to one or more standards. For example, the communications module 430 may allow the example computing device 400 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like.

Additionally or alternatively, the communications module 430 may allow the example computing device 400 to communicate using near-field communication (NFC), via Wi-Fi™, using Bluetooth™ or via some combination of one or more networks or protocols. In some embodiments, all or a portion of the communications module 430 may be integrated into a component of the example computing device 400. For example, the communications module may be integrated into a communications chipset. In some embodiments, the communications module 430 may be omitted such as, for example, if sending and receiving communications is not required in a particular application.

The storage module 440 allows the example computing device 400 to store and retrieve data. In some embodiments, the storage module 440 may be formed as a part of the memory 420 and/or may be used to access all or a portion of the memory 420. Additionally or alternatively, the storage module 440 may be used to store and retrieve data from persisted storage other than the persisted storage (if any) accessible via the memory 420. In some embodiments, the storage module 440 may be used to store and retrieve data in a database. A database may be stored in persisted storage. Additionally or alternatively, the storage module 440 may access data stored remotely such as, for example, as may be accessed using a local area network (LAN), wide area network (WAN), personal area network (PAN), and/or a storage area network (SAN). In some embodiments, the storage module 440 may access data stored remotely using the communications module 430. In some embodiments, the storage module 440 may be omitted and its function may be performed by the memory 420 and/or by the at least one processor 410 in concert with the communications module 430 such as, for example, if data is stored remotely. The storage module may also be referred to as a data store.

Software comprising instructions is executed by the at least one processor 410 from a computer-readable medium. For example, software may be loaded into random-access memory from persistent storage of the memory 420. Additionally or alternatively, instructions may be executed by the at least one processor 410 directly from read-only memory of the memory 420.

FIG. 5 depicts a simplified organization of software components stored in the memory 420 of the example computing device 400 (FIG. 4). As illustrated, these software components include an operating system 500 and an application 510.

The operating system 500 is software. The operating system 500 allows the application 510 to access the at least one processor 410, the memory 420, and the communications module 430 of the example computing device 400 (FIG. 4). The operating system 500 may be, for example, Google™ Android™, Apple™ iOS™, UNIX™, Linux™, Microsoft™ Windows™, Apple OSX™ or the like.

The application 510 adapts the example computing device 400, in combination with the operating system 500, to operate as a device performing a particular function. For example, the application 510 may cooperate with the operating system 500 to adapt a suitable embodiment of the example computing device 400 to operate as the computing device 240 (FIG. 2), the computer system 120, the real-time data provider computer system 150 and/or the open banking computer system 160.

While a single application 510 is illustrated in FIG. 5, in operation the memory 420 may include more than one application 510 and different applications 510 may perform different operations. For example, in at least some embodiments in which the example computing device 400 is functioning as the client device 110, the applications 510 may include an application for displaying a graphical user interface associated with sending an application programming interface request. The computer system 120 may be configured to receive application programming interface requests and may perform operations to respond thereto.

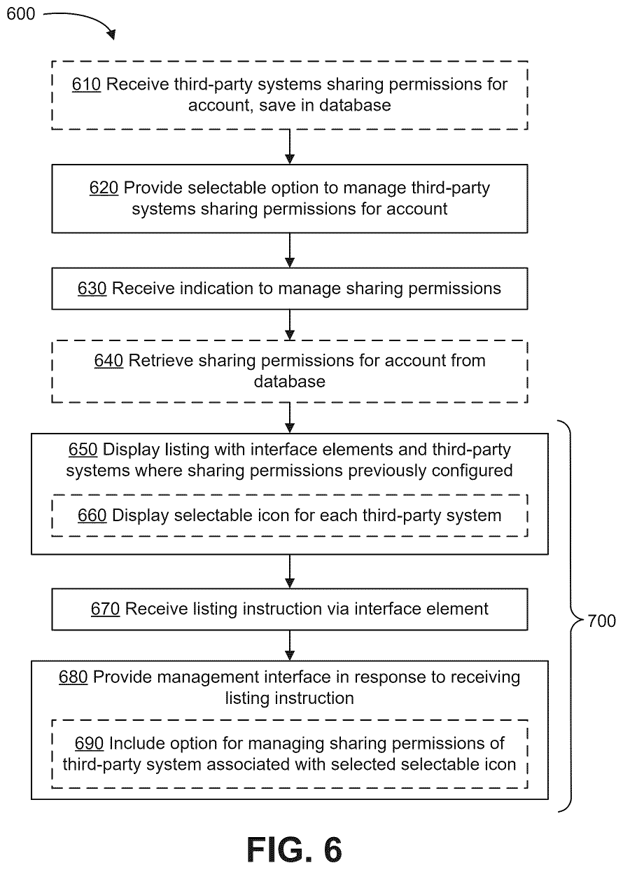

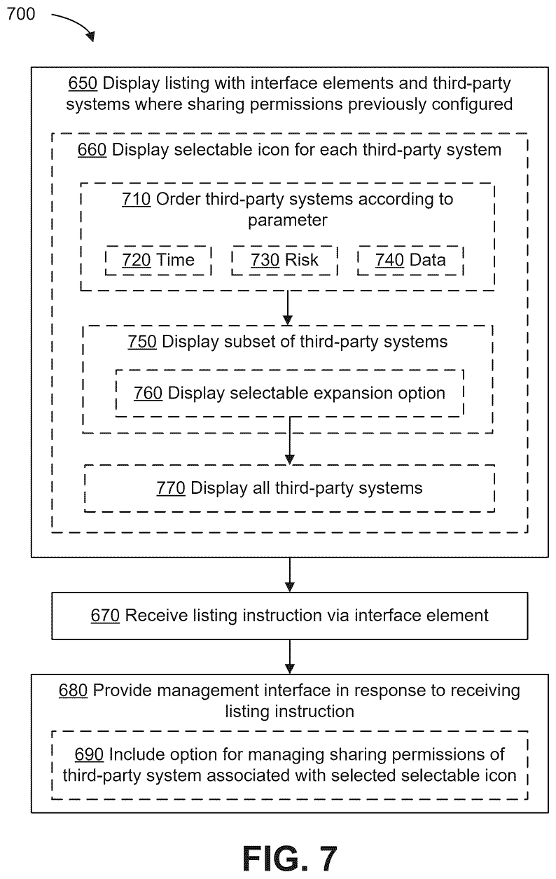

Reference is made to FIGS. 6 and 7, which illustrate, in flowchart form, methods 600, 700 for managing account permissions. The methods 600, 700 may be implemented by a computing device having suitable processor-executable instructions for causing the computing device to carry out the described operations. The methods 600, 700 may be implemented, in whole or in part, by the computer system 120. At least some of the operations may be performed by the permissions management engine 340 and the application programming interface module 310 of the computer system 120.

As noted above, in order for a third-party system to provide a service or (financial) product to a user, a user may grant authorization or permission for a financial institution (for example, associated with the computer system 120) to share some or all of the user's financial data (stored in the database 130 and/or the data store 350) with the third-party system (such has the real-time data provider computer system 150 and/or the open banking computer system 160).

Thus, optionally, at an operation 610, the method 600 may include receiving, from the user (such as via the client device 110), the sharing permission of the third-party system defined for the user's financial account, and saving the sharing permission to the database (such as the database 130) in association with the user's financial account. To that end, multiple sharing permissions associated with multiple third-party systems defined for the user's financial account may be received and saved to the database. The sharing permission(s) may form at least part of the permissions data (such as permissions data 138).

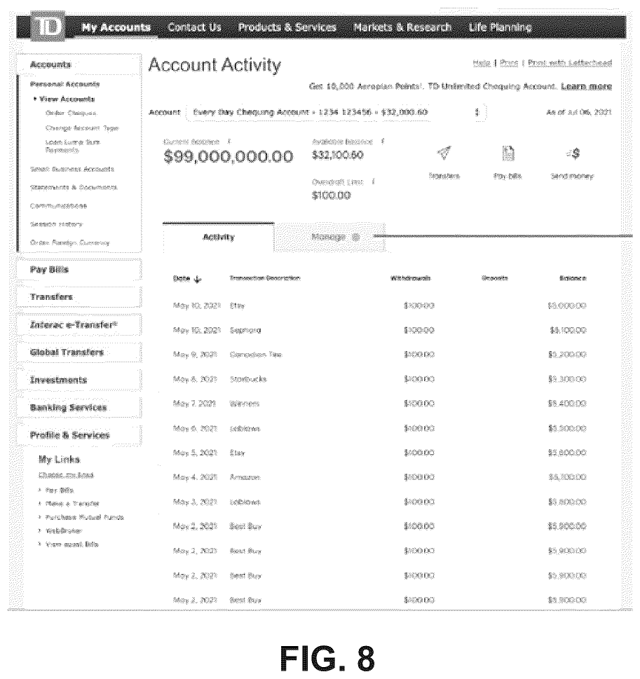

At an operation 620, the method 600 includes providing, in an account view of the financial account, a selectable option to manage the sharing permissions of the third-party systems for the user's financial account. In some embodiments, the user's financial data may be displayed in the account view of the financial account under an “Activity” tab, and the selectable option may be displayed in the form a selectable “Manage” tab in the same account view. See FIG. 8 for example. Arranged in this manner, it may be readily apparent to the user which financial account the sharing permission management tab, and the subsequent third-party systems which will be displayed under it, is/are associated with.

At an operation 630, the method 600 includes receiving an indication to manage sharing permissions of the third-party systems via the selection option. The indication may also be received from the user through the client device 110.

Then at an operation 640, the method 600 may include querying the database (such as the database 130), to retrieve the sharing permissions for the third-party systems defined for the user's financial account.

In response to receiving the indication, at an operation 650, the method 600 includes displaying a listing including only the third-party systems for which the sharing permissions for the financial account have been previously configured. Put another way, of the available third-party systems, the displayed listing would include the third-party systems for which the user had previously granted authorization or permission for the financial institution to share some, or all, of the user's financial data, but not include the third-party systems for which sharing permissions have not been previously granted or configured. The listing is further displayed with one or more interface elements for receiving a listing instruction in association with the listing. The interface elements may be a selectable element.

At an operation 660, each of the third-party systems in the listing may optionally be displayed as a selectable icon, where the interface elements include the selectable icons. In some embodiments, each selectable icon may be a graphic or logo of its corresponding third-party system. The use of selectable icons and logos may help to manage use of limited screen real estate on the client device 110.

At an operation 670, the method 600 includes receiving the listing instruction via the one or more interface elements. For example, the listing instruction may be received by means of selection of one of the selectable icons.

At an operation 680, in response to receiving the listing instruction, the method 600 includes providing a management interface related to the listing. For example, at an operation 690, if the listing instruction was received by means of one of the selectable icons, the management interface provided may then include options for managing the sharing permissions for the third-party system that is associated with the selected selectable icon.

Displaying the listing with only the third-party systems for which the sharing permissions for the financial account have been previously configured may help to focus the user on the third-party systems that are likely to be of importance and relevance to the user, and/or that should be re-evaluated by the user.

Further implementations of the operations 650 and 660 in greater detail are illustrated in FIG. 7 as the method 700. Similar to the method 600, the method 700 may be implemented, in whole or in part, by the computer system 120. At least some of the operations may be performed by the permissions management engine 340 and the application programming interface module 310 of the computer system 120. As noted above, at the operation 650, the listing is displaying having only the third-party systems for which the sharing permissions for the financial account have been previously configured. At the operation 660, each of the third-party systems in the listing may be displayed as a selectable icon.

At an operation 710, the method 700 includes ordering the display of the third-party systems according to one or more parameters. The parameters may include, among others, a time at which the sharing permission of each third-party system was defined (at an operation 720), a risk score defined for each third-party system (at an operation 730), and an amount of data being shared according to the sharing permission of each third-party system (at an operation 740).

For example, at the operation 720, the ordering may involve ordering the listing so that the sharing permissions that were defined most recently are displayed first. Such an ordering may help to provide focus on newly defined sharing permissions. In another example, the ordering may be oldest-first to provide focus to the oldest-defined sharing permissions.

In another implementation, at the operation 730, the listing may be ordered based on a risk score associated with each third-party system. For example, third-party systems that are considered riskier may be displayed first. As noted above, the permissions management engine 340 may include risk parameters that it may use to analyze the trustworthiness or riskiness of a given third-party system.

In another example, at the operation 740, the listing may be ordered based on the amount of data being shared so that the third-party systems consuming more data may be displayed first. The permissions management engine 340 may also have data parameters that it may use to analyze the volume or amount of data provided to a given third-party system.

Ordering the third-party systems in such a manner may further help to provide additional focus on particular sharing permissions that may be of greater importance to, of greater relevance to, and/or that should be re-evaluated by, the user.

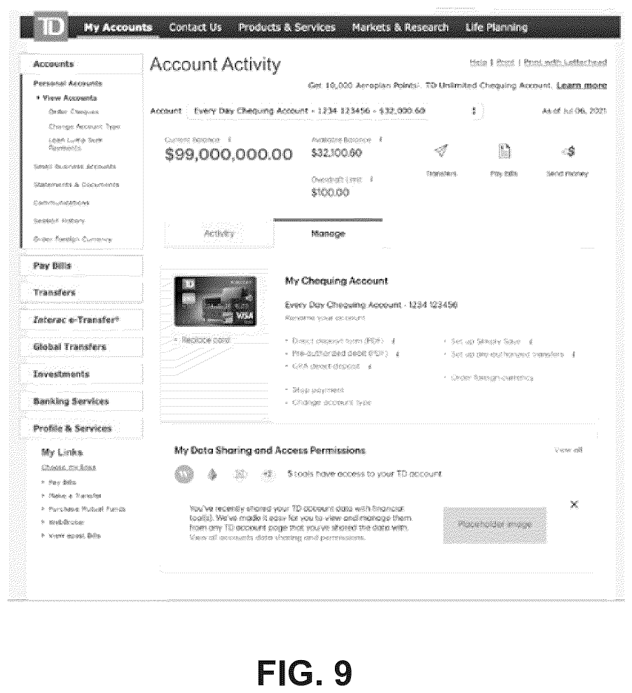

At an operation 750, the method 700 may include displaying a subset or a portion (i.e. not all) of the third-party systems for which the sharing permissions for the financial account have been previously configured. For example, if the there are five third-party systems for which the sharing permissions for the financial account have been previously configured, the subset may include three of the five. See FIG. 9, for example.

In some embodiments, the three third-party systems may be the three third-party systems for which sharing permissions were most recently defined, the three riskiest third-party systems, or the three third-party systems that are consuming the most data. Other parameters may be used to select which of the third-party systems may form the subset to be displayed. Displaying a subset of the third-party systems may further help to manage use of limited screen real estate on the client device 110, and may further help to focus the user on the third-party systems that may be of greater importance to, of greater relevance to, and/or that should be re-evaluated by, the user.

At an operation 760, the method 700 may include displaying a selectable expansion option with the subset of the third-party systems, where the selectable expansion option may be one of the interface elements. In some embodiments, the selectable expansion option may be a selectable “Display All” or “+2” link. See FIG. 9, for example.

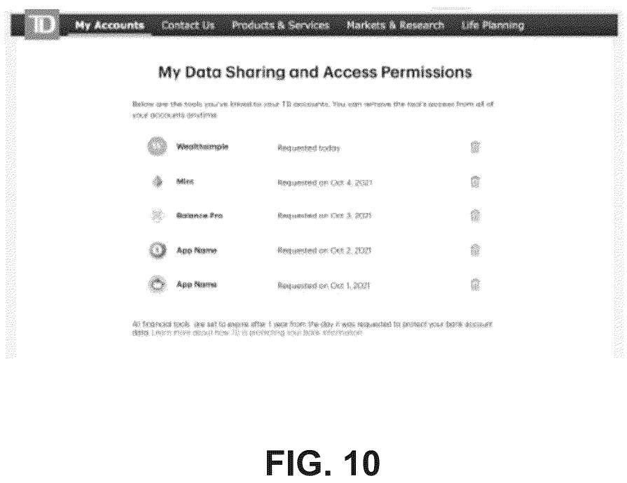

In response to receiving the listing instruction via the selectable expansion option, the method 700 may include displaying all of the third-party systems for which sharing permissions for the financial account have been previously configured (at an operation 770). See FIG. 10, for example.

In some embodiments, the method 700 may skip the operations 750 and 760, and simply display all of the third-party systems in the management interface for which the sharing permissions for the financial account have been previously configured at the operation 770.

At the operation 670, the method 700 includes receiving the listing instruction via the one or more interface elements as described above. Additionally, in some embodiments, the listing instruction may be received by means of selection of one of the selectable icons in the subset or in the listing of all of the third-party systems for which sharing permissions had been previously configured. The listing instruction may also be received by selection of the selectable expansion option.

At the operation 680, in response to receiving the listing instruction, the method 700 includes providing the management interface related to the listing as described above. If the listing instruction is received by means of selection of one of the selectable icons in the subset or in the listing of all of the third-party systems, at the operation 690, the management interface provided may then include options for managing the sharing permissions for the third-party system that is associated with the selected selectable icon.

If a user wishes to manage the existing sharing permissions of their financial data, the user typically checks with potentially relevant third-party application or other financial institution in order to verify which third-party application and/or other financial institutions were previously configured and which permissions were granted, before the sharing permissions can be changed. This can be cumbersome and time-consuming. Such searching and verification may also result in unnecessary application programming interfaces (API) requests being sent or other computer resources unnecessarily being used. This leads to less efficient use of computing resources.

The presently described systems and methods may help a user to manage the sharing permissions without the above-described searching, as the relevant third-party systems are already associated with the user's financial account, and collated in the account view of the user's financial account. This may help to minimize the number of unnecessary API requests the user may make or minimize unnecessary computer resources from being used. Processing power may, thus, be saved before the desired outcome of managing sharing permissions is achieved. This may be particularly beneficial in the case where the client device 110 has limited screen real-estate and limited resources (for example, a handheld mobile device, which typically has a smaller display and fewer computer resources compared to desktop devices).

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computing system comprising:
a processor;
a communications module coupled to the processor; and
a memory coupled to the processor, the memory storing instructions that, when executed, configure the processor to:
provide, in an account view of an account, a selectable option to manage sharing permissions for third-party systems defined for the account;
receive an indication via the selectable option to manage the sharing permissions of the third-party systems;
in response to receiving the indication, display a listing including only the third-party systems for which the sharing permissions for the account have been previously configured, the listing having one or more interface elements for receiving a listing instruction in association with the listing;
receive the listing instruction via the one or more interface elements; and
in response to receiving the listing instruction, provide a management interface related to the listing.

2. The computing system of claim 1, wherein the instructions further configure the processor to display a selectable icon for each of the third-party systems in the listing for which the sharing permissions has been previously configured, the one or more interface elements comprising the selectable icons.

3. The computing system of claim 2, wherein in response to receiving the listing instruction via one of the selectable icons, the instructions further configure the processor to provide the management interface with options for managing the sharing permissions for the third-party system associated with the one of the selectable icons.

4. The computing system of claim 3, wherein the listing is ordered based on one or more of:
a time at which the sharing permission of each third-party system was defined;
a risk score defined for each third-party system; and
an amount of data being shared according to the sharing permission of each third-party system.

5. The computing system of claim 4, wherein the instructions further configure the processor to display the listing with all of the third-party systems for which sharing the permissions for the account have been previously configured.

6. The computing system of claim 4, wherein the instructions further configure the processor to display the listing with a subset of the third-party systems for which the sharing permissions for the account have been previously configured.

7. The computing system of claim 6, wherein the one or more interface elements further comprises a selectable expansion option, and in response to receiving the listing instruction via the selectable expansion option, the instructions further configure the processor to provide the management interface with all of the third-party systems for which the sharing permissions for the account have been previously configured.

8. The computing system of claim 1, wherein the instructions further configure the processor to query a database to retrieve the sharing permissions for the third-party systems defined for the account.

9. The computing system of claim 8, wherein the instructions further configure the processor to receive a given sharing permission of a given third-party system defined for the account, and save the given sharing permission of the given third-party system to the database in association with the account.

10. A computer-implemented method comprising:
providing, in an account view of an account, a selectable option to manage third-party system sharing permissions defined for the account;
receiving an indication via the selectable option to manage the third-party system sharing permissions;
in response to receiving the indication, displaying a listing including only third-party systems for which sharing permissions for the account have been previously configured, the listing having one or more interface elements for receiving a listing instruction in association with the listing;
receiving the listing instruction via the one or more interface elements; and
in response to receiving the listing instruction, providing a management interface related to the listing.

11. The method of claim 10, wherein displaying the listing comprises displaying a selectable icon for each of the third-party systems in the listing for which the sharing permissions has been previously configured, the one or more interface elements comprising the selectable icons.

12. The method of claim 11, wherein in response to receiving the listing instruction via one of the selectable icons, the method further comprises providing the management interface with options for managing the sharing permissions for the third-party system associated with the one of the selectable icons.

13. The method of claim 12, further comprising ordering the listing based on one or more of:
a time at which the sharing permission of each third-party system was defined;
a risk score defined for each third-party system; and
an amount of data being shared according to the sharing permission of each third-party system.

14. The method of claim 13, wherein displaying the listing comprises displaying all of the third-party systems for which the sharing permissions for the account have been previously configured.

15. The method of claim 13, wherein displaying the listing comprises displaying a subset of the third-party systems for which the sharing permissions for the account have been previously configured.

16. The method of claim 15, wherein the one or more interface elements further comprises a selectable expansion option, in response to receiving the listing instruction via the selectable expansion option, the method further comprising providing the management interface with all of the third-party systems for which the sharing permissions for the account have been previously configured.

17. The method of claim 10, further comprising retrieving the third-party system sharing permissions defined for the account from a database.

18. The method of claim 17, further comprising receiving a given sharing permission of a given third-party system for the account, and saving the given sharing permission of the given third-party system to the database in association with the account.

19. A non-transitory computer readable medium having stored thereon processor-executable instructions which, when executed by at least one processor, configure the at least one processor to:
provide, in an account view of an account, a selectable option to manage third-party system sharing permissions defined for the account;
receive an indication via the selectable option to manage the third-party system sharing permissions;
in response to receiving the indication, display a listing including only third-party systems for which sharing permissions for the account have been previously configured, the listing having one or more interface elements for receiving a listing instruction in association with the listing;
receiving the listing instruction via the one or more interface elements; and
in response to receiving the listing instruction, providing a management interface related to the listing.

20. The non-transitory computer readable medium of claim 19, wherein the processor-executable instructions, when executed by the at least one processor, further configure the at least one processor to retrieve the third-party system sharing permissions defined for the account from a database.
